(19) United States
(12) Patent Application Publication
(10) Pub. No.: US 2021/0166231 A1
(43) Pub. Date: Jun. 3, 2021

(54) Blockchain-Based Account Withdrawal Method and System

(71) Applicant: Jinan Zhishu Information and Technology Co., Ltd., Jinan City, SD (US)

(72) Inventor: Lin Han, Jinan City (CN)

(21) Appl. No.: 17/105,395

(22) Filed: Nov. 25, 2020

(30) Foreign Application Priority Data
Nov. 29, 2019 (CN) 201911200226.5

(51) Int. Cl. G06Q 20/40; G06Q 20/06; G06Q 20/38; H04L 9/30; H04L 9/08

(52) U.S. Cl. CPC G06Q 20/401; G06Q 20/065; G06Q 20/3829; G06Q 2220/00; H04L 9/0869; H04L 2209/38; H04L 2209/56; H04L 9/3066

(57) ABSTRACT

The present invention relates to the communication field, and discloses a blockchain-based account withdrawal method. The blockchain-based account withdrawal method comprises: S1: creating a common account and an issuance account, recording an allowable withdrawal time and a withdrawal address into a blockchain ledger through blockchain transfer, and cascading the common account and the issuance account; S2: performing a transfer transaction via the issuance account by a user, and diverting funds by a server to complete the transaction; S3: initiating a withdrawal application by the user within a specified allowable withdrawal time; S4: implementing the withdrawal transaction and withdrawing the funds back to the withdrawal address by the server. Through the configuration of the issuance account, another special transaction, “withdrawal transaction”, is allowed to be initiated within the allowable withdrawal time to withdraw funds of a certain transfer transaction from a previous issuance account back to the withdrawal address of the issuance account which initiates the transfer transaction, such that the transaction security is greatly improved and the problems in prior art are resolved.

### CROSS-REFERENCE TO RELATED APPLICATIONS

This application claims priority to Chinese Application No. 201911200226.5 filed Nov. 29, 2019. The contents from the above are hereby incorporated in their entirety by reference.

### TECHNICAL FIELD

The present application relates to the communication field, in particular to a blockchain-based account withdrawal method and system.

### BACKGROUND

Based on the current blockchain technology (such as the bitcoin technology), each of transfer records is recorded with no central authority using a chain-type ledger, and each of the ledgers connected together is called a block. Once a transaction record is included in the ledger and is fully confirmed by a node with no central authority, it cannot be tampered (which means extremely high tampering cost). As shown in FIG. 1, once digital assesses are transferred using the current blockchain technology, the transfer cannot be concealed. Users do not have a remorse period. If the digital assets are hacked, the transaction cannot be withdrawn either. In particular, financing institutions and giant enterprises with very high requirements on security need a digital asset solution which has very high security and can realize transaction withdrawal.

An existing invention patent, Publication No. CN110428238A, entitled “Account Withdrawing Method and System Based on Block Chain”, relates to a blockchain-based transaction revoking method, which comprises the following steps: a revocable account sends a transfer transaction request to a server; the server executes the transfer transaction request with a delay period 0; the revocable account sends a revoking request to the server within the delay period 0; and the server changes the transfer transaction. Thus it can be seen that, according to the technical solution, the server executes the transfer transaction with a delay after the user initiates a transfer transaction, which greatly prolongs the normal transaction time and affects the use experience of users. Therefore, in view of these, there is an urgent need for a method and system which allow timely transfer without affecting the normal daily use of the user and allow the user to revoke the transfer transaction, which is made out of the user's own free will when the account is hacked.

### SUMMARY OF THE INVENTION

To overcome defects in the prior art, the present application provides a blockchain-based account withdrawal method and system. Through configuration of an issuance account, an allowable withdrawal time and a withdrawal address are recorded into a blockchain ledger through blockchain transfer; another special transaction, “withdrawal transaction”, is allowed to be initiated within the allowable withdrawal time after the transfer traction to withdraw funds of a certain transfer transaction from a previous issuance account back to the withdrawal address of the issuance account which initiates the transfer transaction, such that the transaction security is greatly improved and the problems in prior art are resolved.

The present application is achieved through the following technical solution: A blockchain-based account withdrawal method includes the following steps:

S1: creating a common account and an issuance account, recording an allowable withdrawal time and withdrawal address into a blockchain ledger through blockchain transfer, and cascading the common account and the issuance account;

S2: performing a transfer transaction via the issuance account by a user to complete the transaction;

S3: initiating a withdrawal application by the user within a specified allowable withdrawal time; and,

S4: defining a transfer transaction initiated by the common account as an “irrevocable transaction”, a transfer transaction initiated by the issuance account as a “revocable transaction”, a special transaction which is initiated to execute an operation of withdrawing a certain revocable transaction in the issuance account as a “withdrawal transaction”, a transaction which is not revoked within the allowable withdrawal time as “transaction exceeding the allowable withdrawal time”, and implementing the withdrawal transaction and withdrawing funds back to a withdrawal address by the sever.

Further preferably, the number of the issuance accounts configured is not less than 2, a withdrawal address is set for each of the issuance accounts; the issuance accounts are cascaded, and the terminal of the cascaded issuance accounts is connected to the common account.

Further preferably, the number of block heights of a blockchain represents the allowable withdrawal time, and the number of block heights of the blockchain is not less than 120, which means that the allowable withdrawal time is greater than or equal to 2 hours.

Further preferably, the beginning of an address of the issuance account is marked with a blockchain address code, and the beginning of an address of the common account is marked with a transfer address code.

Further preferably, the withdrawal address is an address of a certain common account or issuance account; and funds are withdrawn back to the withdrawal address in an attribute of the issuance account when conditions are satisfied and funds withdrawal occurs.

A blockchain-based account withdrawal system includes a common account terminal, which comprises a key pair which is formed based on an algorithm, and is configured to encode a public key to generate an account address;

an issuance account terminal, which comprises a key pair, an address, an allowable withdrawal time and a withdrawal address, and is configured to record the allowable withdrawal time and withdrawal address into a blockchain ledger through blockchain transfer;

a server, configured to execute a withdrawal transaction and a transfer transaction; and,

a storage module, configured to store a program code for implementing an account withdrawal method.

Further preferably, the key pair is generated on the basis of bitcoin and an ellipse algorithm through a random seed or a seed word or hierarchical deterministic derivation.

### Beneficial Effects of the Invention

1. According to the blockchain-based account withdrawal method of the present application, a user can execute normal transfer transactions through the issuance account without delaying the transfer, which brings convenience in use to the user and ensures that funds can enter an account quickly;

2. According to the present application, a transaction can be revoked within a specified time limit; when the issuance account is hacked and transfer occurs out of the user's own free will, the user himself/herself can initiate a “withdrawal transaction” to withdraw the target transferred funds back to the withdrawal address of the account;

3. According to the present application, a plurality of issuance accounts can be set; the withdrawal address of one issuance account 1 can be another issuance account 2; the withdrawal address of the issuance account 2 can be the next issuance account 3; the rest can be done in the same cascading way; and the withdrawal address of the last issuance account must be the address of a common account. When the transfer transaction of the issuance account 1 undergoes a fund withdrawal operation, funds are withdrawn back into the issuance account 2; if the funds are transferred again from the issuance account 2, a withdrawal transaction can be initiated within the allowable withdrawal time to withdraw the funds back into the issuance account 3; the rest can be done in the similar way until the funds are withdrawn back into the common account. In this process, for any fund transfer of the issuance accounts, the user can wait for the fund transfer to exceed the allowable withdrawal time, such that the fund transfer becomes irrevocable.

4. According to the present application, the common account and the issuance account are set, such that the user can deposit a small amount of funds in the common account for daily payment in case that a payment cannot be withdrawn; the user can deposit a large amount of funds which are not usually used into the issuance account, and set a reasonable allowable withdrawal time and a withdrawal address for the issuance account, such that funds in the issuance account can be withdrawn and protected in case of emergencies. When it needs to use the funds in the issuance account, a plan can be made to transfer a part of or all of the funds from the issuance account into the daily used common account; after the transfer, the user only needs to wait until the allowable withdrawal time passed, and then the transferred funds irrevocably enter a target account. When the issuance account is hacked and a transfer occurs out of the user's own free will, the user himself/herself can initiate a “withdrawal transaction” to withdraw the target transferred funds back into the withdrawal address of the account. The present application is reasonably set and suitable for wide popularization and application.

### DESCRIPTION OF THE DRAWINGS

FIG. 1 is a flowchart of a blockchain-based transfer transaction in prior art.

FIG. 2 is a flowchart of a blockchain-based account withdrawal method according to one embodiment of the present application.

FIG. 3 is a schematic view of an issuance account according to the present application.

FIG. 4 is a schematic view of multi-stage cascading of the issuance accounts according to the present application.

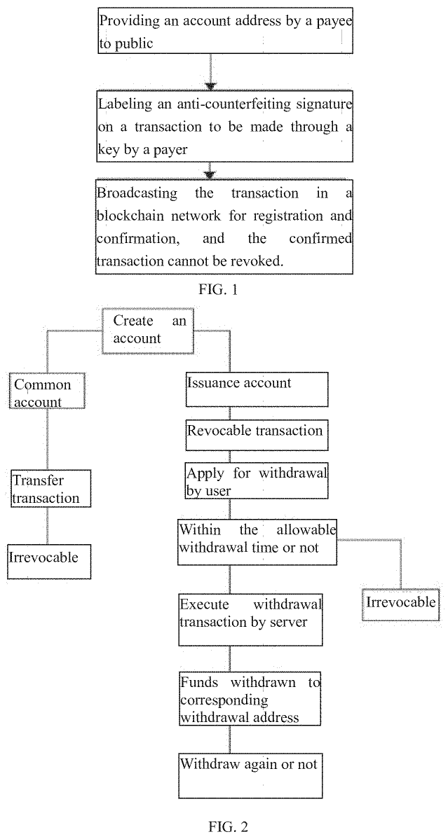

### DETAILED DESCRIPTION OF THE INVENTION

To clarify the technical characteristics of the present solution, the present application has been illustrated in detail through the following description with reference to the specific embodiments and attached drawings.

### EXAMPLE 1

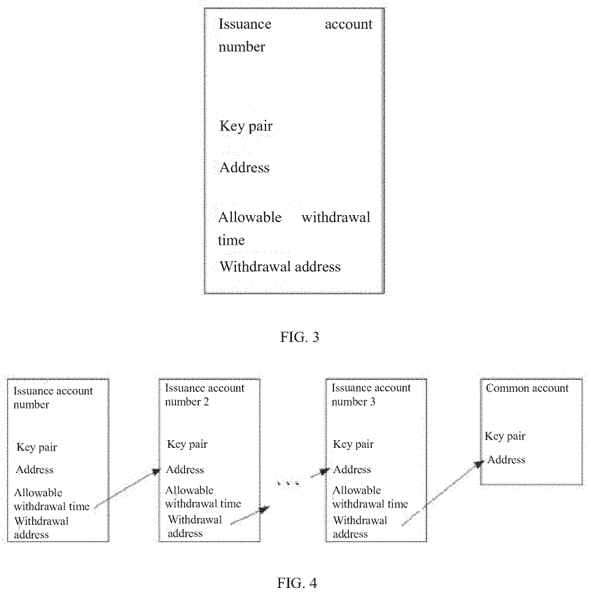

As shown in FIG. 2-FIG. 3, this example discloses a blockchain-based account withdrawal method, including the following steps: S1: creating a common account and an issuance account, recording an allowable withdrawal time and a withdrawal address into a blockchain ledger through blockchain transfer, and cascading the common account and the issuance account; S2: performing a transfer transaction via the issuance account by a user, and diverting funds by a server to complete the transaction; S3: initiating a withdrawal application by the user within a specified allowable withdrawal time; S4: defining a transfer transaction initiated by the common account as an “irrevocable transaction”, a transfer transaction initiated by the issuance account as a “revocable transaction”, a special transaction which is initiated to execute an operation of withdrawing a certain revocable transaction in the issuance account as a “withdrawal transaction”, a transaction which is not revoked within the allowable withdrawal time as “transaction exceeding the allowable withdrawal time”, and implementing the withdrawal transaction and withdrawing funds back to a withdrawal address by the sever.

Create a common account: The common account has the following key attributes: a key pair including a public key and a private key, and an account address generated by encoding the public key. A payee provides an account address to public; a payer uses its own private key to label an anti-counterfeiting signature on a transaction to be made and broadcasts the transaction with the anti-counterfeiting signature to a blockchain network for registration and confirmation; once the transaction is confirmed , funds are transferred to the account of the payee, and the payer has no right to withdraw the funds. The creation of a common account refers to the generation of a key pair thereof. The key pair can be generated based on different algorithms such as the bitcoin and the ellipse algorithm which is frequently used in the blockchain in various ways such as a random seed or a seed word or hierarchical deterministic derivation. For example, Invention Patent, Publication No. CN106452727A, discloses a bitcoin-based key pair generating method, and Patent, Publication No. CN105281896A, entitled “Secret Key POS Machine Activation Method and System Based on Ellipse Algorithm”, discloses a method for generating a key pair based on the ellipse algorithm. Therefore, key pair generating methods belong to the prior art and are not described in detail herein. The generated key pair includes a private key and a public key, where the private key needs to be kept confidential, cannot be disclosed, and is configured to label an anti-counterfeiting signature on a transaction to be made, and the public key can be encoded to generate the account address.

Create an issuance account: On the basis of the common account, two attributes, the allowable withdrawal time and the withdrawal address, are added to establish a new type of account, which is called “issuance account”. This means that key attributes of the issuance account include a key pair, an account address, an allowable withdrawal time and a withdrawal address. First, the key pair and the address are generated by the foregoing method; then, two attributes, the allowable withdrawal time and the withdrawal address provided by the user, are recorded into the blockchain ledger through a special blockchain transfer, such that the two attributes become a part of the attributes of the issuance account, and once the setting is completed, the two attributes cannot be modified thereafter.

The allowable withdrawal time refers to a time frame, for example, 1 hour, 1 day, or 1 month. In a blockchain system, the number of block heights is used to represent time. For example, the mean generation time of each of blocks in the blockchain system is 1 minute, which means that a mean block height represents 1 minute. Then, one-hour allowable withdrawal time can be represented by 60 block heights. The withdrawal address is the address of a certain common account or issuance account. Funds are withdrawn back to the withdrawal address in an attribute of the issuance account when conditions are satisfied and funds withdrawal occurs. The beginning of the address of the issuance account is marked with a blockchain address code, and the beginning of the address of the common account is marked with a transfer address code.

In use, when the account initiates an outward transfer transaction, the target address and the amount of the transfer transaction need to be labeled with an anti-counterfeiting signature through the private key of the account. Another special transaction, “withdrawal transaction”, is allowed to be initiated within the allowable withdrawal time after the transaction is made, to withdraw funds of a certain transfer transaction, i.e. a revocable transaction, from a previous issuance account back to the withdrawal address of the issuance account which initiates the transfer transaction.

In the present design mechanism, the reason why the funds are not directly withdrawn back to the original account number is that, once the account is hacked, it is very likely that the private key thereof has been controlled by the hacker, so that even if the funds are withdrawn back to the original account, the hacker can still manipulate the private key of the account to make transfers. The account is not well protected. Therefore, in actual use, the user cannot set the withdrawal address as the address of the account itself.

### EXAMPLE 2

As shown in FIG. 3-FIG. 4, a plurality of issuance accounts are created; the allowable withdrawal time and withdrawal address in each of the issuance accounts are recorded into a blockchain ledger through blockchain transfer; the plurality of issuance accounts are cascaded, and the terminal of the cascaded issuance accounts is connected to a common account.

When a user revokes a transaction, the withdrawal address of one issuance account 1 can be another issuance account 2; the withdrawal address of the issuance account 2 can be the next issuance account 3; the rest can be done in the same cascading way; and the withdrawal address of the last issuance account must be the address of the common account. When the transfer transaction of the issuance account 1 undergoes a fund withdrawal operation, funds are withdrawn back into the issuance account 2; if the funds are transferred again from the issuance account 2, a withdrawal transaction can be initiated within the allowable withdrawal time to withdraw the funds back into the issuance account 3; the rest can be done in the similar way until the funds are withdrawn back into the common account. In this process, for any fund transfer of the issuance accounts, the user can wait for the fund transfer to exceed the allowable withdrawal time, such that the fund transfer becomes irrevocable.

### EXAMPLE 3

Combined use of a common account and an issuance account: a small amount of funds is deposited in the common account for daily payment in case that a payment cannot be withdrawn; a large amount of funds which are not usually used is deposited into the issuance account, and the issuance account is set with a reasonable allowable withdrawal time and a withdrawal address, for example, 2 hours and a withdrawal address, such that funds in the issuance account can be withdrawn and protected in case of emergencies. When it needs to use the funds in the issuance account, a plan can be made to transfer a part of or all of the funds from the issuance account into the daily used common account; after the transfer, the user only needs to wait until the allowable withdrawal time passed, and then the transferred funds irrevocably enter the target account. When the issuance account is hacked and a transfer occurs out of the user's own free will, the user himself/herself can initiate a “withdrawal transaction” to withdraw the target transferred funds back into the withdrawal address of the account.

In conclusion, according to the blockchain-based account withdrawal method of the present application, a user can make normal transfer transactions through the issuance account without a delay in the transfer time, which brings convenience in use to the user and ensures that funds can quickly enter the target account. Moreover, the transaction can be revoked within a specified time; when the issuance account is hacked and a transfer occurs out of the user's own free will, the user himself/herself can initiate a “withdrawal transaction” to withdraw the target transferred funds back to the withdrawal address of another account. According to the present application, a plurality of issuance account can be set; when the transfer transaction of an issuance account 1 undergoes a fund withdrawal operation, funds are withdrawn back into an issuance account 2; if the funds are transferred again from the issuance account 2, a withdrawal transaction can be initiated within the allowable withdrawal time to withdraw the funds back into an issuance account 3; and the rest can be done in the similar way until the funds are withdrawn back into the common account.

Matters which are not described in detail in the present application all belong to technologies well known to those skilled in the art. Finally, it should be noted that, the above embodiments are merely used to illustrate the technical solution of the present application, and are not intended to limit the present application. Even if preferred embodiments are used to describe the present application in further detail, an ordinarily skilled in the art shall understand that, the technical solution of the present application can still be modified or equivalently substituted. All modifications or equivalent institutions made within the spirit of the technical solution of the present application shall fall within the protective scope of the claims of the present application.

What is claimed is:

1. A blockchain-based account withdrawal method, comprising the following steps:
S1: creating a common account and an issuance account, recording an allowable withdrawal time and withdrawal address into a blockchain ledger through blockchain transfer, and cascading the common account and the issuance account;
S2: performing a transfer transaction via the issuance account by a user, and diverting funds by a server to complete the transaction;
S3: initiating a withdrawal application by the user within a specified allowable withdrawal time; and,
S4: defining a transfer transaction initiated by the common account as an “irrevocable transaction”, a transfer transaction initiated by the issuance account as a “revocable transaction”, a special transaction which is initiated to execute an operation of withdrawing a certain revocable transaction in the issuance account as a “withdrawal transaction”, a transaction which is not revoked within the allowable withdrawal time as “transaction exceeding the allowable withdrawal time”, and implementing the withdrawal transaction and withdrawing funds back to the withdrawal address by the sever.

2. The blockchain-based account withdrawal method according to claim 1, wherein at least one issuance account is set, a withdrawal address is set for each of the issuance accounts, the issuance accounts are cascaded, and the terminal of the cascaded issuance accounts is connected to the common account.

3. The blockchain-based account withdrawal method according to claim 1, wherein the number of block heights of a blockchain represents the allowable withdrawal time, and the number of block heights of the blockchain is not less than 120, and the allowable withdrawal time is greater than or equal to 2 hours.

4. The blockchain-based account withdrawal method according to claim 1, wherein the beginning of an address of the issuance account is marked with a blockchain address code, and the beginning of an address of the common account is marked with a transfer address code.

5. The blockchain-based account withdrawal method according to claim 1, wherein the withdrawal address is an address of a certain common account or issuance account; and
funds are withdrawn back to the withdrawal address in an attribute of the issuance account when conditions are satisfied and funds withdrawal occurs.

6. A blockchain-based account withdrawal system, comprising: a common account terminal, which comprises a key pair which is formed based on an algorithm, and is configured to encode a public key to generate an account address;
an issuance account terminal, which comprises a key pair, an address, an allowable withdrawal time and a withdrawal address, and is configured to record the allowable withdrawal time and withdrawal address into a blockchain ledger through blockchain transfer;
a server, configured to execute a withdrawal transaction and a transfer transaction; and,
a storage module, configured to store a program code for implementing an account withdrawal method.

7. The blockchain-based account withdrawal system according to claim 6, wherein the key pair is generated on the basis of bitcoin and an ellipse algorithm through a random seed or a seed word or hierarchical deterministic derivation.
